(19) United States
(12) Patent Application Publication
(10) Pub. No.: US 2025/0292042 A1
(43) Pub. Date: Sep. 18, 2025

(54) DEVICES AND METHODS FOR OPERATING A VARIABLE-FOCUS IMAGING ASSEMBLY

(71) Applicant: ZEBRA TECHNOLOGIES CORPORATION, Lincolnshire, IL (US)

(72) Inventors: Yuri Astvatsaturov, Lake Forest, IL (US); Carl D. Wittenberg, Water Mill, NY (US)

(21) Appl. No.: 18/608,809

(22) Filed: Mar. 18, 2024

(51) Int. Cl. G06K 7/10; G06K 7/14

(52) U.S. Cl. CPC G06K 7/10722; G06K 7/1413

(57) ABSTRACT

Devices, systems, and methods for operating a variable-focus imaging assembly. An example system includes the variable-focus imaging assembly; a controller; and one or more processors configured to (a) determine if the variable-focus imaging assembly is within a threshold state of motion; (b) responsive to the variable-focus imaging assembly being within the threshold state of motion, cause the variable-focus imaging assembly to: (i) perform at least one focus operation; (ii) capture at least one image frame; and (iii) transmit the at least one image frame to a host; and (c) responsive to the variable-focus imaging assembly being outside the threshold state of motion, cause the variable-focus imaging assembly to abstain from at least one of: (i) performing the at least one focus operation; (ii) capturing the at least one image frame; and (iii) transmitting the at least one image frame to the host.

### BACKGROUND

Barcode reading systems, such as a handheld indicia reader, may determine the distance between the barcode reading system and a target object, such as an object having a barcode. The barcode reading system may use the distance to set a focus of its variable-focus imaging assembly for capturing in-focus images of the barcode, for example to use the in-focus images for identification and decoding of the barcode. However, if the user of the handheld indicia reader activates the indicia reader by pulling it's trigger before it is “locked-in” on the target object and while the indicia reader is still in motion, the indicia reader may, as a result, determine an erroneous distance to the object, capture out-of-focus images of the target object which are incapable of being decoded, initiate one or more focus operations attempting to locate and/or capture in-focus images of the object, and/or cause the user to re-scan the object in an attempt to successfully decode the object's barcode, any of which may waste time, energy, and frustrate the user. As such, systems and methods which operate the variable-focus imaging assembly based upon detecting a threshold state of motion of the barcode reading system may reduce or eliminate the deleterious effects of focus operations which provide inaccurate distance information and/or result in unsuccessful decodes, decrease user checkout times, reduce power and resource consumption of the barcode reader system, and/or improve the user's overall experience during a scanning session.

### SUMMARY

In an embodiment, the present disclosure discloses a method for operating a variable-focus imaging assembly. The method may include: (a) determining if the variable-focus imaging assembly is within a threshold state of motion; (b) responsive to the variable-focus imaging assembly being within the threshold state of motion, causing the variable-focus imaging assembly to: (i) perform at least one focus operation; (ii) capture at least one image frame; and (iii) transmit the at least one image frame to a host; and (c) responsive to the variable-focus imaging assembly being outside the threshold state of motion, causing the variable-focus imaging assembly to abstain from at least one of: (i) performing the at least one focus operation; (ii) capturing the at least one image frame; and (iii) transmitting the at least one image frame to the host.

In a variation of the embodiment, the at least one focus operation may include a ranging operation causing the variable-focus imaging assembly to determine a distance between the variable-focus imaging assembly and a target; and set a focus of the variable-focus imaging assembly based upon the distance between the variable-focus imaging assembly and the target.

In another variation of the embodiment, the at least one focus operation may include a ranging operation causing the variable-focus imaging assembly to: determine a distance between the variable-focus imaging assembly and a target; and set a focus of the variable-focus imaging assembly based upon the distance between the variable-focus imaging assembly and the target.

In yet another variation of the embodiment, the method may further include, responsive to a trigger event, performing (a)-(c) until at least one of: exceeding a timeout period; or receiving a termination signal.

In still yet another variation of the embodiment, the termination signal may be: received from the host; and based upon a successful decode of an indicia in the at least one image frame by the host.

In a variation of the embodiment, determining if the variable-focus imaging assembly is within the threshold state of motion may include: capturing, via the variable-focus imaging assembly, a first image frame and a second image frame; and determining if the variable-focus imaging assembly is within the threshold state of motion based upon comparing at least one first image frame parameter of the first image frame and at least one second image frame parameter of the second image frame.

In another variation of the embodiment, the first image frame and the second image frame may each have a lower resolution than the at least one image frame.

In yet another variation of the embodiment, the at least one first image frame parameter may include a brightness parameter; and the at least one second image frame parameter includes the brightness parameter.

In still yet another variation of the embodiment, the host may be a decoding processor configured to decode an indicia in the at least one image frame.

In a variation of the embodiment, the variable-focus imaging assembly and the decoding processor may be housed in a common sealed housing.

In another embodiment, the present disclosure discloses a system for operating a variable-focus imaging assembly. The system may include the variable-focus imaging assembly; a controller of the variable-focus imaging assembly; one or more processors; and a memory storing instructions that, when executed by the one or more processors, cause the one or more processors to: (a) determine if the variable-focus imaging assembly is within a threshold state of motion; (b) responsive to the variable-focus imaging assembly being within the threshold state of motion, cause the variable-focus imaging assembly to: (i) perform at least one focus operation; (ii) capture at least one image frame; and (iii) transmit the at least one image frame to a host; and (c) responsive to the variable-focus imaging assembly being outside the threshold state of motion, cause the variable-focus imaging assembly to abstain from at least one of: (i) performing the at least one focus operation; (ii) capturing the at least one image frame; and (iii) transmitting the at least one image frame to the host.

In yet another embodiment, the present disclosure discloses a tangible machine-readable medium including instructions that, when executed, may cause a machine to at least: (a) determine if a variable-focus imaging assembly is within a threshold state of motion; (b) responsive to the variable-focus imaging assembly being within the threshold state of motion, cause the variable-focus imaging assembly to: (i) perform at least one focus operation; (ii) capture at least one image frame; and (iii) transmit the at least one image frame to a host; and (c) responsive to the variable-focus imaging assembly being outside the threshold state of motion, cause the variable-focus imaging assembly to abstain from at least one of: (i) performing the at least one focus operation; (ii) capturing the at least one image frame; and (iii) transmitting the at least one image frame to the host.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective front and back view of an example scanner in accordance with various embodiments;

FIG. 2 illustrates a block diagram of an example imaging device such as the example scanner of FIG. 1;

FIG. 3A illustrates an example aiming pattern on an object located at a close-in distance from an example imaging device, such as the example imaging device of FIG. 2;

FIG. 3B illustrates an example aiming pattern on an object located at a far-out distance from an example imaging device, such as the example imaging device of FIG. 2;

FIG. 4A illustrates an example field of view (FOV) in which an example imaging device projects an aiming pattern onto an object and focuses on the object;

FIG. 4B illustrates an example imaging device in a state of motion while projecting an aiming pattern;

FIG. 4C illustrates an example FOV in which an example imaging device in motion is positioned at a first angle;

FIG. 4D illustrates an example FOV in which an example imaging device in motion is positioned at a second angle;

FIG. 4E illustrates an example FOV in which an example imaging device is positioned at a third angle, and affixed on a target object;

FIG. 4F illustrates an example out of focus image of a target object;

FIGS. 5A and 5B illustrate a signal diagram of an example scenario for operating a variable-focus imaging assembly, according to the techniques described herein; and

FIG. 6 illustrates a flow diagram of an example method of operating a variable-focus imaging assembly, according to the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously described, operating a variable-focus imaging assembly of an indicia reader while it is outside a threshold state of motion may result in the execution of focus operation (e.g., ranging operations, image capture operations) that waste time, energy and/or resources of the indicia reader and/or the user of the indicia reader. Therefore, it is an objective of the present disclosure to provide systems and methods capable of operating a variable-focus imaging assembly based upon determining if the variable-focus imaging assembly is within a threshold state of motion. “Within a threshold state of motion” as used herein, may also include being within a threshold state of stability, i.e., determining if the imaging assembly is moving too much/outside a threshold relative to the environment that the imaging assembly is attempting to image. Responsive to the variable-focus imaging assembly being outside the threshold state of motion, the variable-focus imaging assembly of the indicia reader may abstain from (i) performing the at least one focus operation; (ii) capturing the at least one image frame; and/or (iii) transmitting the at least one image frame to the host (e.g., a point-of-sale, a server, a decoding processor, etc.) allowing the indicia reader to more quickly decode an indicia (e.g., when within the threshold state of motion), which may preserve resources of the indicia reader otherwise spent taking such actions, and also reduce the user's checkout time, providing the user with a more efficient and enjoyable checkout experience.

It should be understood that the indicia and indicia scanning/decoding methods are referenced herein primarily as barcode and barcode scanning/decoding for the purposes of discussion only. The systems and methods of the present disclosure may apply to any indicia (e.g., barcodes, quick response (QR) codes, a graphic, a logo, etc.) associated with an object.

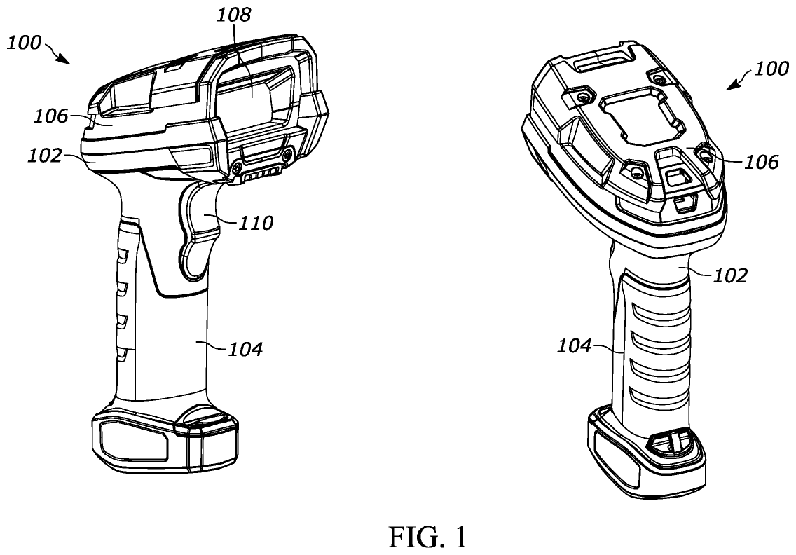

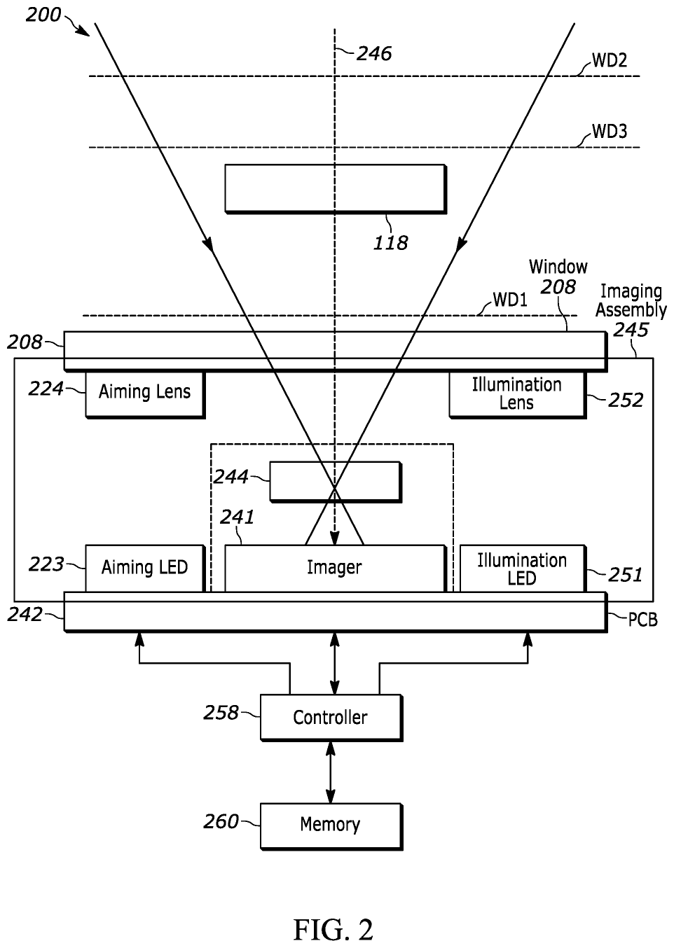

Turning to the Figures, FIG. 1 illustrates an example indicia reader 100 having a housing 102 with a handle portion 104 and a head portion 106. The head portion 106 includes a window 108 and is configured to be positioned on the top of the handle portion 104. The head portion 106 includes an imaging lens (e.g., imaging lens 244 as described with respect to FIG. 2 below) that, depending on the implementation, is and/or includes a variable-focus optical element.

The handle portion 104 is configured to be gripped by a reader user (not shown) and includes a trigger 110 for activation by the user. Optionally included in an embodiment is a base portion (not shown), which may be attached to the handle portion 104 opposite the head portion 106 and is configured to stand on a surface and support the housing 102 in a generally upright position. The indicia reader 100 may be used in a hands-free mode as a stationary workstation when it is placed on a countertop or other workstation surface. The indicia reader 100 may also be used in a handheld mode when it is picked up off the countertop or base station and held in an operator's hand. In the hands-free mode, products may be slid, swiped past, or presented to the window 108 for the reader to initiate barcode reading operations. In the handheld mode, the indicia reader 100 may be moved towards a barcode on a product, and the trigger 110 may be manually depressed or engaged to initiate a ranging operation and/or otherwise imaging of the barcode.

Other implementations may provide only handheld or only hands-free configurations. In the embodiment of FIG. 1, the indicia reader 100 is ergonomically configured for a user's hand as a gun-shaped housing 102, though other configurations may be utilized as understood by those of ordinary skill in the art. As shown, the lower handle 104 extends below and rearwardly away from the body 102 along a centroidal axis obliquely angled relative to a central FOV axis of a FOV of an imaging assembly within the scanning head 106.

Referring next to FIG. 2, a block diagram of an example architecture for an imaging device 200 is shown, such as the handheld indicia reader 100. In at least some implementations, the imaging device 200 includes a light-detecting sensor or imager 241 operatively coupled to, or mounted on, a printed circuit board (PCB) 242 of the imaging device 200, as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging assembly 245 over a FOV along an imaging axis 246 through the window 208. The imager 241 may also include and/or function as a monochrome sensor and, in further implementations, a color sensor. It should be understood that the terms “imager”, “image sensor”, “imaging sensor”, and the like are used interchangeably herein. Depending on the implementation, the imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

The return light is scattered and/or reflected from an object 118 over the FOV. The imaging lens 244 is operative for focusing the return light onto the array of image sensors to enable the object 118 to be imaged. In particular, the light that impinges on the pixels is sensed and the output of those pixels produce image data that is associated with the environment that appears within the FOV (which may include the object 118). This image data is typically processed by a controller 258 (usually by being sent to a decoder) which identifies and decodes decodable indicia captured in the image data. Once the decode is performed successfully, the indicia reader may signal a successful “read” of the object 118 (e.g., a barcode). The object 118 may be located anywhere in a working range of distances between a close-in working distance (WD1) and a far-out working distance (WD2). In an implementation, WD1 is about one and six-tenths (1.6) inches from the window 208, and WD2 is about thirty (30) inches from the window 208.

In some implementations, the imaging lens 244 includes a variable-focus optical element. In further implementations, the variable-focus optical element is a lens operated and/or adjusted by a ball-bearing motor lens or a voice coil motor (VCM) actuator (i.e., a VCM lens). In implementations in which the variable-focus optical element is a ball-bearing motor or VCM lens, the ball-bearing motor or VCM lens may have a focus range from one and six-tenths (1.6) inches extending infinitely (i.e., to optical infinity), or any other suitable focus range. In further embodiments, the variable-focus optical element may be any lens or optical element with a similar capability to adjust focus, such as a liquid lens, a T-lens, a ball-bearing focusing actuator and any other similar lens known in the art. Depending on the implementation, the controller 258 or other processor associated with the imaging assembly 245 may control the variable-focus optical element.

An illumination assembly may also be mounted in, attached to, or associated with the imaging device 200. The illumination assembly may include an illumination light source 251, such as at least one light emitting diode (LED) or other suitable light source, and at least one illumination lens 252, and preferably a plurality of illumination light sources and illumination lenses, configured to generate a substantially uniform distributed illumination pattern of illumination light on and along the object 118 to be imaged by image capture. At least part of the scattered and/or reflected return light is derived from the illumination pattern of light on and along the object 118.

Although FIG. 2 illustrates a single illumination source 251, it will be understood that the illumination light source 251 may include more illumination sources. In at least one implementation, the illumination assembly may include at least one near field illumination assembly (e.g., at least one near field illumination source and at least one illumination lens 252) and at least one far field illumination assembly (e.g., at least one far field illumination source and at least one illumination lens 252). In at least some embodiments, the illumination light source 251 may include a near field illumination source, such as a near field LED, and a far field illumination source, such as a far field LED. In at least some implementations, the near field illumination source may be suitable for illuminating objects nearer to the imaging device 200 (e.g., when capturing an image of the object 118, which may include an indicia for decoding) as compared to the far field illumination light source which may be a suitable illumination light source for illuminating the object 118 further from the imaging device 200. The illumination sources comprising the illumination light source 251 may be separately and non-simultaneously energized, simultaneously energized, or any combination thereof.

In at least one implementation, the light sources of the illumination light source 251 may have different illumination capabilities, power levels or other illumination characteristics from one another. For example, the light sources may be different, e.g., one or more of infrared (IR), LED, organic LED (OLED), etc. In another example, the near field illumination light source may be capable of sufficiently illuminating the object 118 for imaging purposes (e.g., decoding a barcode) up to a certain distance from the imaging device 200 (e.g., in a zone between WD1 and WD3), whereas the far field illumination source may be capable of sufficiently illuminating the object 118 beyond the distance of the near field illumination LED for imaging purposes (e.g., in a zone between WD3 and WD2). In at least one implementation, the far field illumination source may provide illumination such that it may be less suitable and/or non-ideal for imaging the object 118 closer than a certain distance to the imaging device 200 (e.g., closer than WD3). For example, energizing the far field illumination source to illuminate the object 118 at certain distances may result in an over-exposure of the object 118 and/or indicia thereupon when captured in an image by the imaging device 200. Accordingly, one or more of the illumination light sources 251 may only be energized when the imaging device 200 images an object at a distance associated with certain range value for which an illumination light source 251 would be most appropriate. Illuminating the object 118 using the most appropriate illumination source 251 may provide improved exposure of the object/indicia in the captured images.

An aiming light assembly may also be mounted in, attached to, or associated with the imaging device 200 and preferably includes an aiming light source 223, e.g., one or more aiming LEDs and/or laser light sources, and an aiming lens 224 for generating and directing a visible aiming light beam away from the imaging device 200 onto the object 118 in the direction of the FOV of the imager 241.

In at least some implementations, at least the imager 241, the imaging lens 244, the illumination assembly comprising the illumination light source 251 and the illumination lens 252, and the aiming light assembly comprising the aiming light source 223 and the aiming lens 224, may be collectively referred to as the imaging assembly 245 and/or a variable-focus imaging assembly 245. In at least some implementations, the variable-focus imaging assembly 245 may include additional components, such as the PCB 242, the window 208, a indicia decoding processor (not shown), and/or any other suitable component.

The imager 241, the illumination light source 251, the aiming light source 223, and/or the variable-focus imaging assembly 245 may be operatively connected to a programmed microprocessor or controller 258 operative for controlling the operation of these components. In some implementations, the controller 258 is, or includes, an imaging processor configured to process images (e.g., decode indicia, compare image parameters, etc.). In further implementations, the controller 258 functions as, or is communicatively coupled to, the imaging processor for receiving, processing, and/or analyzing the image data captured by the imager 241. As used herein, the term “image data” may at times be used interchangeably with the terms “image,” “images”, “image frame,” image frames,” and the like. In at least one embodiment, the imaging device 200 may include an indicia decoder (e.g., a barcode scanner) communicatively coupled with the imaging assembly 245 and/or controller 258, and configured to receive image data, locate and/or decode one or more indicia captured in the image data, compare image parameters (e.g., to detect motion), or any other suitable image processing. In at least one embodiment, the indicia decoder, also referred to as an indicia decoding module and/or a decoding processor) may be controlled independently (e.g., via controller 258 or other suitable processor, device and/or component) from the imaging assembly 245. In at least some embodiments, the indicia decoder may be part of an indicia decoding module. In at least some embodiments, the indicia decoder and/or indicia decoding module may be part of the imaging device 200 and/or the imaging assembly 245 (e.g., housed in a common sealed housing), or may be a separate component which is not part of the imaging device 200 and/or the imaging assembly 245, but is in communication with, and/or operably connected to, the imaging device 200 and/or the imaging assembly 245.

In some implementations, the controller 258 may include, or be communicatively coupled to, a device and/or component used to detect a threshold state of motion of the imaging device 200 and/or the imaging assembly 245 (generally referred to hereinafter as the state of motion of the imaging assembly 245). In at least one implementation, the motion detecting device and/or component may include a motion sensor, such as an accelerometer, a gyroscope, a magnetometer, an inertial measurement unit (IMU), and/or other suitable device and/or component able to sense a state of motion of the imaging assembly 245.

In at least one implementation, one or more components of the imaging device 200 may be used to determine whether the imaging assembly 245 is within the threshold state of motion. In at least one implementation, the imaging device 200 may capture a first image frame and a second image frame via the imaging assembly 245. The first and second image frames may be images captured during a ranging operation, referred to as ranging frames, which may be of lower resolution than non-ranging images (e.g., images captured for indicia decoding). The imaging device 200 may compare (e.g., via the controller 258, an imaging processor, and/or any other suitable processor/component) at least one parameter of the first image frame and at least one parameter of the second image frame, to determine whether the imaging assembly 245 is within the threshold state of motion. The parameter of each image may be, for example, a brightness parameter, and based upon detecting a change in brightness between the first image and the second image frame, it may be determined whether the imaging assembly 245 is in a state of motion, and further whether the state of motion is within, or outside of, the threshold state of motion. In one implementation, comparing the brightness of the first image frame and the second image frame may include computing and comparing the histograms of the first and second image frames, or portions thereof. In one implementation, comparing the brightness of the first and second image frames may include comparing the brightness values of pixels across the entirety of the image frames, or a portion of the image frames, and determining if there is a sufficiently large change across a sufficiently large numbers of pixels with respect to the pixel brightness values. In other implementations, other suitable devices and/or components may be used to detect the threshold state of motion of the imaging assembly 245.

The controller 258 may cause the imaging device 200 and/or the variable-focus imaging assembly 245, to perform or abstain from one or more actions, operations (e.g., focus operations), and the like, based upon whether the state of motion of the imaging assembly 245 is within a threshold state of motion, or outside of the threshold state of motion. In at least one implementation, responsive to the imaging assembly 245 being within the threshold state of motion, the controller 258 may cause the imaging assembly 245 to (i) perform at least one focus operation; (ii) capture at least one image frame; and/or (iii) transmit the at least one image frame to a host.

In at least one implementation, responsive to the imaging assembly 245 being outside the threshold state of motion, the controller 258 may cause the imaging assembly 245 to abstain from performing the at least one focus operation. This may avoid, for example, the likelihood of the imaging assembly 245 entering a ramping operation due to activation of the imaging device 200 (e.g., via the trigger) while in a state of motion and/or not yet sufficiently aimed at an object. In at least one implementation, responsive to the imaging assembly 245 being outside the threshold state of motion, the controller 258 may cause the imaging assembly 245 to abstain from capturing at least one image frame. This may prevent, for example, the imaging assembly 245 from capturing images which may not be in-focus or may otherwise be inadequate for decoding an indicia in the images, due to the state of motion of the imaging assembly 245. In at least one implementation, responsive to the imaging assembly 245 being outside the threshold state of motion, the controller 258 may cause the imaging assembly 245 to abstain from transmitting at least one image frame to the host, which may avoid the delay caused by the host attempting to decode an indicia in a high-motion image captured during a state of motion. This may include abstaining from transmitting at least one image frame to the host for a limited period of time, setting a time-out period associated how long the host may attempt to decode an indicia in the image, and/or any other suitable parameter.

Although in the aspects just described, the controller 258 may cause the imaging assembly 245 perform one or more actions, operations, etc., when the imaging assembly 245 is within the threshold state of motion, and cause the imaging assembly 245 to abstain from performing one or more actions, operations, etc., when outside the threshold state of motion, this is for case of illustration only. The controller 258 may cause the imaging assembly 245 to perform one or more actions/operations, and/or prevent the imaging assembly 245 from performing one or more actions/operations, than those just described, based upon the state of motion. For example, when a threshold state of motion is detected, the controller 258 may set the focus of the imaging assembly 245 to a predetermined focus position, or cause the imaging assembly 245 to cycle through a limited number of focus positions (e.g., during a ramping operation), etc.

A memory 260 is connected and accessible to the controller 258. Preferably, the controller 258 is the same as the one used for processing the captured return light from the illuminated object 118 to obtain data related to the object 118. Although not shown, additional optical elements, such as collimators, lenses, apertures, compartment walls, etc. may be provided in the housing. Although FIG. 2 shows the imager 241, the illumination light source 251, and the aiming light source 223 as being mounted on the same PCB 242, it should be understood that different implementations of the imaging device 200 may have these components each on a separate PCB, or in different combinations on separate PCBs. For example, in an implementation of the imaging device 200, the illumination LED source 251 is provided as an off-axis illumination (i.e., has a central illumination axis that is not parallel to the central FOV axis).

In some implementations, the object 118 is, or includes, an indicia for decoding (e.g., a decode indicia), such as a barcode, a QR code, a label, a UPC code, a digital matrix code, logo, image, etc. In further implementations, the object 118 is or includes a digital watermark, which may include a plurality of repeating barcodes, product codes, code patterns, or other such indicia that comprise the digital watermark. In some such implementations, the digital watermark is invisible or near-invisible to the human eye but is able to be detected and/or imaged by an imaging device 200.

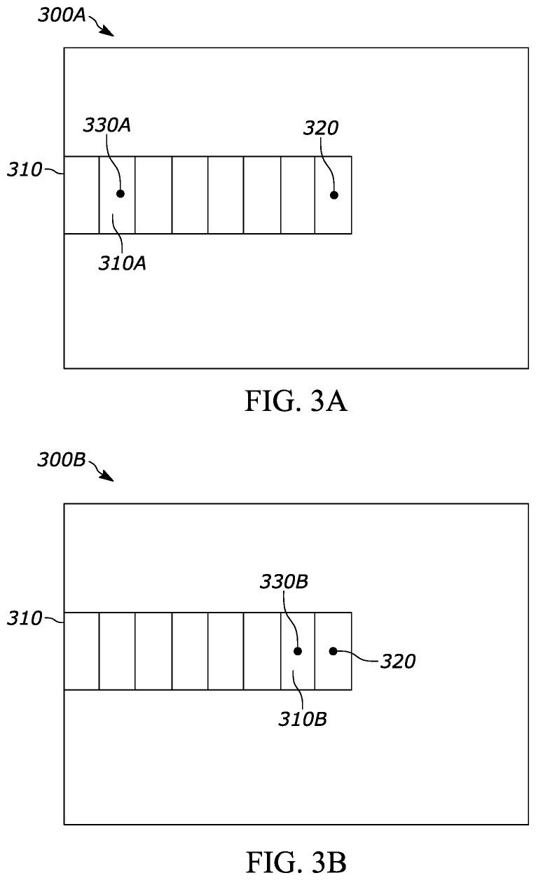

FIGS. 3A and 3B illustrate aiming patterns 330A, 330B in a first ranging frame 300A, and a second ranging frame 300B, respectively. Ranging frames 300A, 330B include the same FOV, with the first ranging frame 300A illustrating the aiming pattern 330A being projected from the imaging device 200 a first distance, the second ranging frame 300B illustrating the aiming pattern 330B being projected from the imaging device 200 at a second, farther distance. In particular, in at least some embodiments, the imaging device 200 may determine (e.g., via the controller 258 during a ranging operation) a distance between a center point 320 and an aiming pattern 330A and 330B (e.g., as projected by an aiming module such as aiming LED 223 and aiming lens 224) to determine a distance between the imaging device 200 and the object being imaged. In at least some embodiments, the FOV may be divided into an equal number of imaging regions 310. Based on which region the aiming pattern 330A and/or 330B falls into, the imaging device 200 (e.g., via the controller 258 or other suitable component/processor) may determine a distance between the imaging device 200 and the object, such as object 118. In at least some embodiments, determining the distance between the center point 320 and the aiming pattern 330A and 330B is not necessary if using imaging regions 310 to determine the distance between the imaging device 200 and the object, e.g., each imaging region being associated with at least one distance between the imaging device 200 and the object. It will be understood that, although the exemplary embodiments of FIGS. 3A and 3B depict eight imaging regions 310 of equal size, that the imaging device 200 may, depending on the embodiment, divide the FOV into four regions, sixteen regions, thirty-two regions, or other suitable number of regions. Similarly, the imaging regions 310 may be of different shapes and/or sizes.

In some implementations, the imaging device 200 may be calibrated during manufacture to accommodate, possibly among other tolerances, a tolerance in the separation between the imager 241 and the aiming light source 223 and/or a tolerance in an optical alignment of the imager 241 and the aiming light source 223. Such manufacturing tolerances affect the amount of and/or the geometry of parallax between the imager 241 and the aiming light source 223. Accordingly, the imaging device 200 may store a calibration table (e.g., in memory 260) indicating such calibrations, information associated with the imaging regions, focal zones (also referred to simply as “zones”) or, equivalently, each respective ones of a finite plurality of fixed focus distances which comprise focal zone.

In some implementations, the object distances and/or their associated range values may be stored in memory, for example as a look-up table (LUT) in the memory 260. When the distance between the imaging device 200 and the object 118 is known, e.g., via a ranging operation, the imaging device 200 (e.g., via the controller such as controller 258, an imaging processor, or other suitable device and/or component) may access the LUT and retrieve the associated range value based on the known distance. The range value may be stored in, and/or retrieved from, a memory, such as memory 260, by the imaging device 200 at one or more times, such as proximate conducting a ranging operation, an image capture operation (e.g., distance-based, focus bracketing, or ramping operations) or a decode operation. The memory 260 and/or LUT may also store other information, such as focus parameters and/or illumination parameters associated with one or more focus distances, focal zones (comprising multiple focus distances, such as neighboring focus distances), object distances, range values, etc. The focus parameters may indicate a focus of the variable-focus imaging assembly 245, which may include a focus value, also referred to as a focal distance, or any other suitable parameter(s) associated with variable-focus imaging assembly 245 (e.g., the imager 241, the variable-focus optical element of the imaging lens 244) for capturing images. The illumination parameters may indicate an illumination of the variable-focus imaging assembly 245, which may include a selection of one or more illumination sources, a brightness level, or any other suitable parameter(s) associated with variable-focus imaging assembly 245 (e.g., the illumination light source(s) 251, the illumination lens 252) for capturing images.

In at least some implementations, when the aiming pattern 330A and/or 330B is not detected (e.g., the aiming pattern 330A, 330B does not reflect off the surface of an object with a sufficient level of brightness to be detected by the imaging device 200), the ranging operation may result in the distance and/or range value to the object being unknown to the imaging device 200. In some implementations, the imaging device 200 may use a default focus value (e.g., a focus value stored in local memory 260), when one or more subsequent ranging operations do not result in a consistent range value, e.g., the range value changes between ranging operations, or when the ranging operation does not result in any range value, e.g., when the distance to an object cannot be determined, resulting in the inability to establish a distance during the ranging operation. In one example, the default focus value is a focus value saved in memory during a previous ranging and/or image capture operation, and may associated with the last known range value of the imaging device 200. In one example, the default focus value may include one or more predetermined focus values, such as a “sweet spot” focus value associated with a distance the target object is most likely to be located at with respect to the imaging assembly 245, e.g., based upon historical range values from historical ranging operations, based upon a user input indicating a sweet spot distance, etc. In at least some implementations, the unknown range value may result in retrieving the last known range value from the memory, initiating a subsequent ranging operation to determine a distance/range value, or initiating a focus operation (e.g., distance-based, focus bracketing, ramping operations) based on the last known range value, and/or any other suitable action.

In at least some implementations, the controller 258 may cause the imaging assembly 245 to initiate a focus operation. In some embodiments, the focus operation may include a ranging operation, e.g., to determine the distance between the variable-focus imaging assembly 245 and an object. A user of the indicia reader may initiate the ranging operation by engaging the trigger of the indicia reader, such as trigger 110 of indicia reader 100. In response, the controller 258, an imaging processor, or other suitable device and/or component may energize the aiming light source 223 to project the aiming light into the FOV, such as aiming patterns 330A and 330B. The controller 258, the imaging processor, or other suitable device and/or component may cause the imaging assembly 245 to capture one or more images (e.g., ranging frames) comprising image data of the FOV. The imaging device 200 may determine (e.g., via the controller 258, the imaging processor, or other suitable device and/or component) the distance between the variable-focus imaging assembly 245 and the object being imaged, as previously described. The controller 258 (or other suitable component/processor) may use the distance to determine an associated range value, focus parameters and/or illumination parameters associated with the distance and/or range value, etc. The controller 258 may set a focus of the variable-focus imaging assembly 245 based upon the focus parameters and/or illumination parameters associated with the distance, e.g., to conduct a focus operation such as a distance-based operation, focus bracketing operation, or ramping operation.

In at least some implementations, the focus operation may include a distance-based operation. In at least one implementation, the controller 258, the imaging processor, or other suitable device and/or component, may initiate the distance-based operation after the ranging operation. The distance-based operation may include the controller 258 energizing an illumination assembly (e.g., illumination light source 251 and illumination lens 252) to provide illumination of the FOV during the distance-based operation, and capturing, using the imaging assembly 245, one or more images comprising image data of the environment appearing in the FOV at a fixed focus position. The fixed focus position may have associated focus parameters and/or illumination parameters, e.g., as indicated in a LUT as previously described. The fixed focus position may be based upon a distance and/or range value (e.g., determined by a ranging operation, the distance and/or range value stored in a memory). In one example, the ranging operation preceding the distance-based operation may determine a target object is located twenty-five (25) inches from the variable-focus imaging assembly 245. During the distance-based operation for the focus distance of twenty-five (25) inches, the controller may cause the variable-focus imaging assembly 245 to successively capture six (6) images of the FOV including the target object, with each image captured at focus distance of twenty five (25) inches using the focus parameters and illumination parameters associated with this distance.

In some embodiments, the focus operation may include a focus bracketing operation. In at least one implementation, the controller 258, the imaging processor, or other suitable device and/or component, may initiate the focus bracketing operation after a ranging operation, or after the distance-based operation. The focus bracketing operation may include the controller 258 causing the variable-focus imaging assembly 245 to capture a first set of one or more images at first focus distance of a first focal zone, and capture a second set of one or more images at second focus distance of a second focal zone, the second focal zone being adjacent to the first focal zone. The focus bracketing operation may also include capturing additional sets of images in adjacent focal zones using associated focus distances. The focal zone may be based upon a target object distance and/or range value, and include associated focus parameters and/or illumination parameters associated with the focal zone (e.g., one or more focus distances of the focal zone). The range value for the focus bracketing operation may be the range value stored in memory (e.g., user provided value), the range value from a new ranging operation, the range value from a previous ranging and/or image capture operation (e.g., the range value of the distance-based operation), or any other suitable range value. The multiple focus distances of the focus bracketing operation may include a series of successive focus distances proximate one another and within a single focal zone. In one example, a ranging operation preceding the focus bracketing operation may determine an object is located twenty-five (25) inches from the variable-focus imaging assembly 245, in associated focal zone of thirteen (13) having a focal zone range of twenty (20) inches through thirty (30) inches. During the focus bracketing operation for the focus distance of twenty-five (25) inches, the imaging device may successively capture a series of six (6) images of the FOV which includes the target object, with one image each captured at focus distances of (i) twenty (20) inches, (ii) twenty-two (22) inches, (iii) twenty-four (24) inches, (iv) twenty-six (26) inches, (v) twenty-eight (28) inches, and (vi) thirty (30) inches, all of which fall within focal zone thirteen (13). The one or more images captured across the six focus distances may each use the focus parameters and illumination parameters associated with their respective focus distance, e.g., those indicated by the LUT, the calibration table, etc.

In some embodiments, the focus operation may include a ramping operation. In at least some aspects, the ramping operation may be initiated when a distance cannot be determined during a ranging operation, when other image capture operations (e.g., the distance-based or focus bracketing operations) do not result in a successful indicia decode, or in any other suitable scenario. The controller 258 may initiate the ramping operation to successively capture one or more images at one or more associated focal zones. In some implementations, the ramping operation may include, at each focal zone, the controller 258 causing the imaging assembly 245 to capture at least one image using focus parameters and illumination parameters corresponding to the focal zone. A decode operation may be attempted on the captured images (e.g., via the host) to decode an indicia within the captured images. If the decode operation is successful, the ramping operation may end. If the decode is not successful, the ramping operation may repeat the aforementioned steps for another focal zone as part of a ramping sequence. The ramping sequence may include moving through successive focal zones (which may but do not have to be adjacent to one another) in an incremental manner, and capturing one or more images at each focal zone. In one example, ramping may include successively ramping up or ramping down through all the focal zones during the ramping sequence, i.e., moving from focal zone fifteen (15), then to focal zone fourteen (14), then to focal zone thirteen (13), etc., eventually down to zone zero (0) at the end of the ramping zones, and if the ramping sequence is not ended, and then ramping in the other direction, i.e., moving from focal zone zero (0), then to focal zone one (1), then to focal zone two (2), etc., and so on. In one example, the controller 258 may perform a ramping operation using only a portion of the focal zones, which may be referred to as a focus ramping operation.

In at least some implementations, an image capture operation such as the distance-based operation, focus bracketing operation and/or the ramping operation may come to an end upon receiving (e.g., by the controller 258) a terminal signal. The terminal signal may be received (e.g., from a host) in response to the successful decode of an indicia in the captured image data, may be received in response to the user of the imaging device ending the scanning operation (e.g., by releasing the trigger 110 of an indicia reader 100), may be received in response to a system fault or loss of power, or any other suitable condition causing a terminal signal to be received. In at least some implementations, the image capture operation may come to an end due to a timeout (e.g., if after sixty (60) seconds, the imaging device doesn't receive the termination signal), or in any other suitable manner.

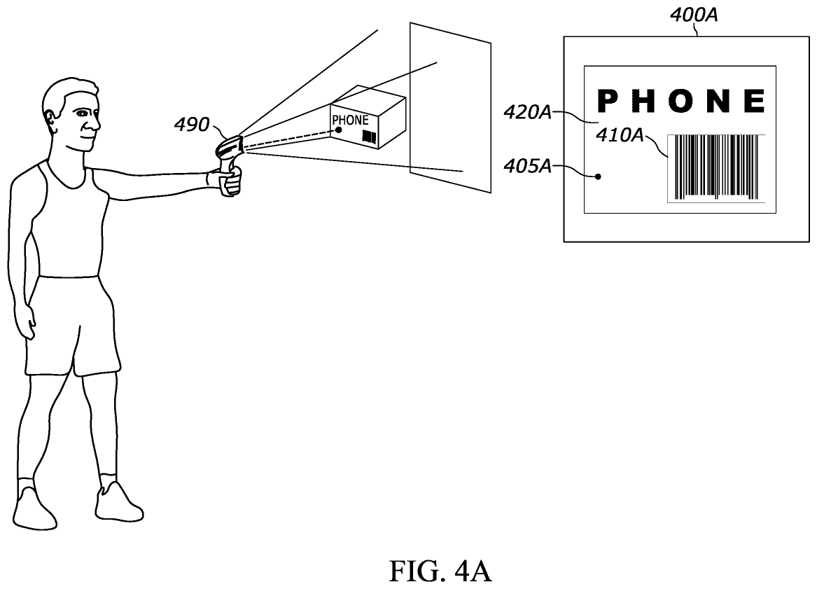

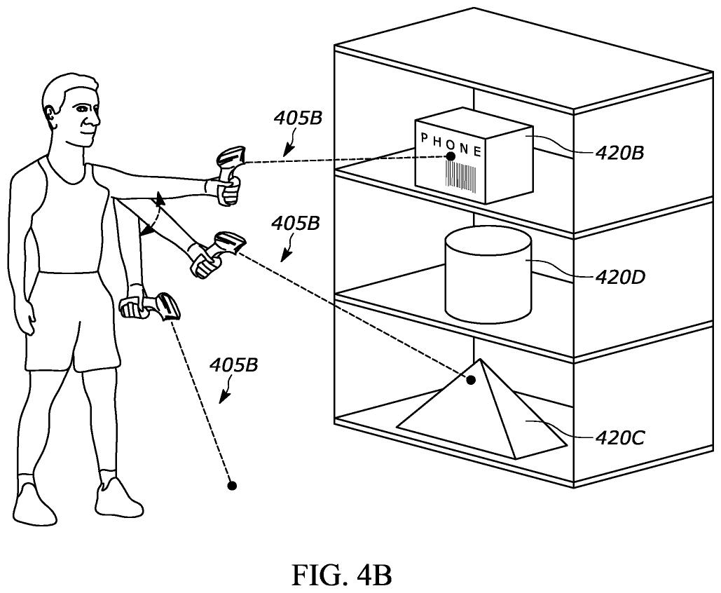

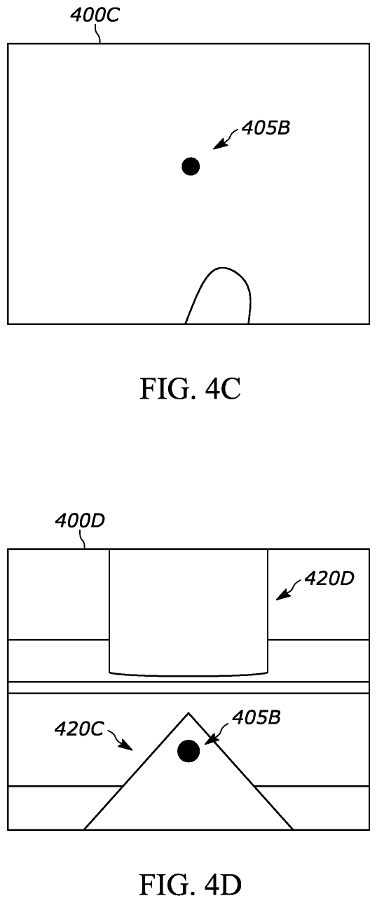

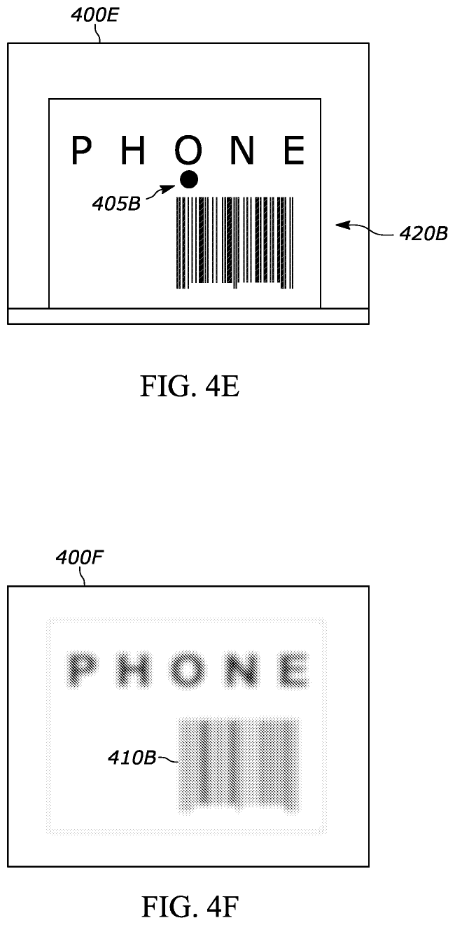

Referring next to FIG. 4A, an imaging device 490 (e.g., indicia reader 100, imaging device 200, etc.) captures images of a FOV 400A. In particular, FIG. 4A depicts an embodiment in which the imaging device 490 is affixed and properly aimed at a target object 420A when the imaging device trigger is activated by the user. Activating the trigger causes the imaging device 490 to project an aiming pattern 405A onto the target object 420A, and focus the imaging assembly of the imaging device 490 on the target object 420A, e.g., during a ranging operation and subsequent distance-based operation. As the aiming pattern 405A is properly positioned on the object 420A, the object 420A and a decode indicia 410A (e.g., barcode) associated with the object 420A, are adequately in-focus (e.g., clear) in the image of the FOV 400.

FIG. 4B depicts an embodiment in which an imaging device 490 is in a state of motion while projecting an aiming pattern 405B. The trigger of the imaging device 490 is activated by the user while the imaging device 490 is pointed at the ground, and not yet properly aimed at the object 420B. The trigger remains activated while the imaging device 490 is in a state of motion as the user raises the imaging device 490 to aim at the object 420B. In general, activating the trigger before the imaging device 490 is aimed at the target object 420B will cause the aiming pattern 405B to be projected onto something other than the target object 420B.

According to the embodiment of FIG. 4B, when the user first activates the trigger of the imaging device 490 while the imaging device 490 is pointed downward at a first angle, a ranging operation is initiated which projects the aiming pattern 405B into the FOV 400C depicted in FIG. 4C. The FOV 400C includes the edge of the object 420C on the lowest shelf.

As the trigger of the imaging device 490 remains activated while the imaging device 490 is moved by the user to a second angle, the aiming pattern 405B is projected into the FOV 400D depicted in FIG. 4D. The FOV 400D includes a portion of the object 420C on the lowest shelf, and a portion of the object 420D on the middle shelf.

The user eventually aims the imaging device 490 at the target object 420B while the trigger is activated, and remains affixed on the target object 420B at a third angle, ceasing motion of the imaging device 490. At the third angle, the aiming pattern 405B is projected into the FOV 400E, as depicted in FIG. 4E.

Activating the trigger of the imaging device 490 while the user moves the imaging device 490 through the first and second angles to arrive at the third angle affixed on the target object 420B, may have one or more deleterious effects. In one implementation, the motion may cause multiple ranging operations to be conducted while the imaging device 490 is in motion, resulting in multiple inconsistent and/or incorrect range values, if the range values are able to be determined at all due to the motion. In one implementation, the range value(s) of the ranging operation(s) while the imaging device 490 is in motion may cause the imaging assembly to use one or more focus values to capture images which end up being out of focus. FIG. 4F depicts an example out of focus image 400F of the target object 420B, which may result from such an implementation. The image 400F may result in an unsuccessful decode of the decode indicia 410B in the image 400F, by a host processing the out of focus image 400F. In an embodiment where multiple out of focus images are captured during motion of the imaging device 490, the host may be unable to decode any of the images. In one implementation, the motion may cause the imaging device 490 to enter a ramping operation, e.g., when the ranging operations during the motion result in inconsistent range values or no range value, or when decode attempts (e.g., of blurry images) are unsuccessful, as just described. The deleterious effects of activating the trigger of the imaging device 490 while it is in motion can waste resources of the imaging device 490, among other system components, such as wasting: processing and power resources to carry out the ranging and/or ramping operations resulting from the motion; memory resources to store images (e.g., out of focus images which cannot be decoded) capturing during operations while the imaging device 490 is in motion; network resources to transmit images captured while in motion to a host for decoding; and/or decoding resources (e.g., of the host) from unsuccessful attempts to decode out of focus images, as well wasting the time of the user, thereby causing frustration.

To address the shortcomings of operating the imaging device in a state of motion, an imaging device (e.g., indicia reader 100, imaging device 200, imaging device 490, etc.) may determine if the imaging assembly, such as a variable focus imaging assembly 245, is within a threshold state of motion. As there may be some motion associated with the use of the imaging device, for example a handheld indicia reader 100 may not be expected to be perfectly still during an imaging operation, a threshold may be associated with the state of motion which, if exceeded, may indicate a likelihood the imaging device is not being pointed at the target object, indicate the captured images have a likelihood of not being decoded (e.g., due to indicia being absent or out-of-focus in images), etc. As previously discussed, one or more sensors such as accelerometers and the like may be used to determine whether the threshold state of motion is exceeded, comparing parameters (e.g., brightness) of at least a portion of frames/images captured by the imaging device may be used to determine whether the threshold state of motion is exceeded, however, any other suitable device, component, method, etc., may be used to determine whether the threshold state of motion is exceeded.

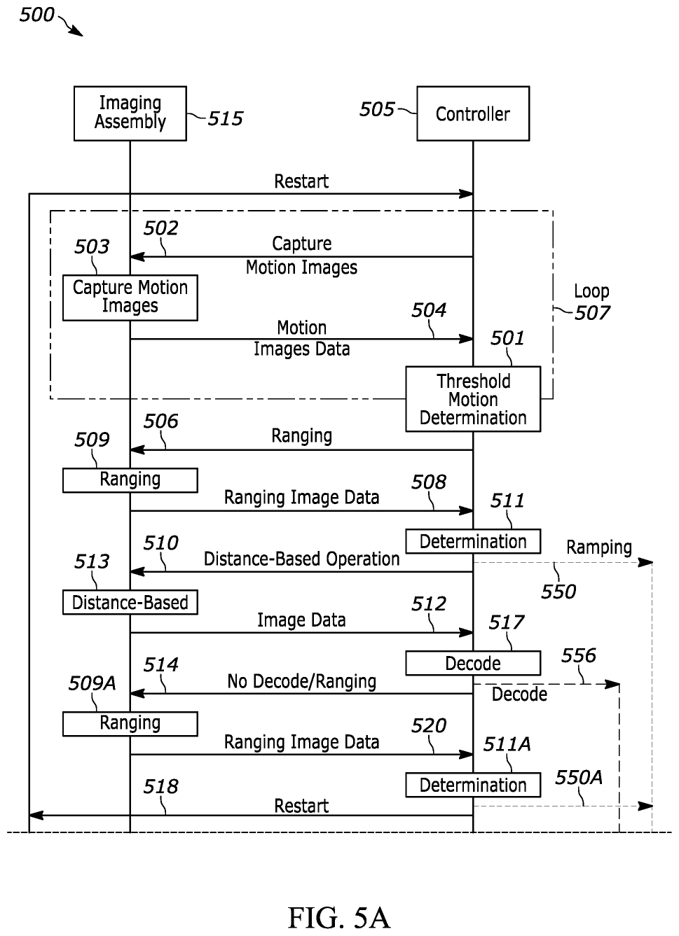

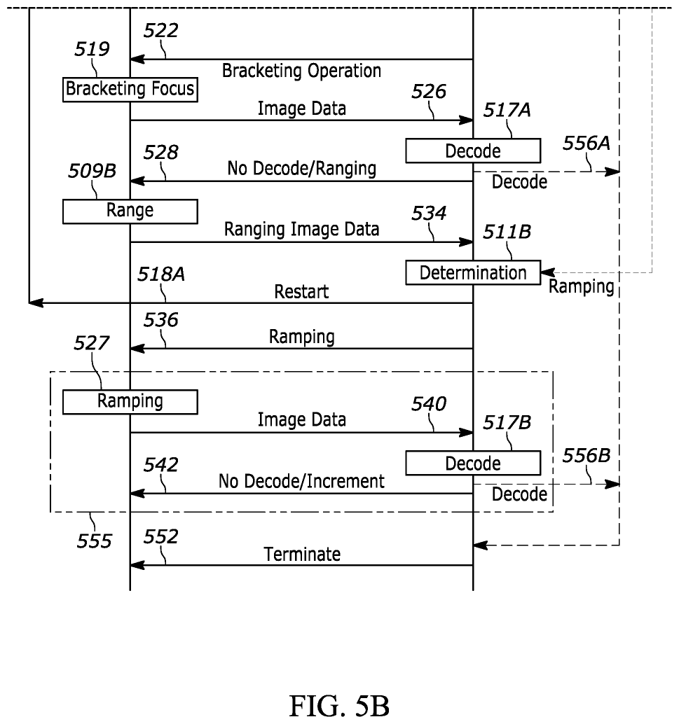

Referring next to FIGS. 5A and 5B, a scenario 500 is illustrated for operating a variable-focus imaging assembly 515, for example based upon determining if the variable-focus imaging assembly 515 is within a threshold state of motion. The scenario 500 of FIGS. 5A and 5B includes an imaging device controller 505 (e.g., the controller 278) communicatively coupled to the variable-focus imaging assembly 515 (e.g., the imaging assembly 245). In some implementations, the variable-focus imaging assembly 515 includes an illumination assembly and aiming light assembly, such as the illumination assembly and the aiming light assembly described with respect to the imaging device 200. Depending on the implementation, the controller 505 and the variable-focus imaging assembly 515 may be components of the same device, such that transmissions as described below may be or include messages, signals, instructions, and/or other indications that are transmitted internally. In other implementations, the controller 505 and the variable-focus imaging assembly 515 may be different devices, and transmit the transmissions between the different devices.

In at least some implementations, the scenario 500 may commence when the controller 505 receives an initialization signal, such: as when a user of the imaging device (e.g., indicia reader 100, imaging device 200) engages a trigger of the imaging device (e.g., trigger 110 of indicia reader 100), upon detection of an object in the FOV of the imaging device, such as detecting a user of the imaging device and/or object to be scanned, or based upon any other suitable initialization signal received by the controller 505 to initiate the scenario 500.

Once the scenario 500 is initialized, the controller 505 may determine 501 if the variable-focus imaging assembly 515 is within a threshold state of motion. In at least some implementations, at least one motion sensor, such as an accelerometer, may be used to determine the state of motion of the variable-focus imaging assembly 515. For example, the motion sensor may provide a motion metric (e.g., speed, acceleration, gravitational force, etc.) which may indicate the state of motion of the variable-focus imaging assembly 515. In at least some implementations, and as depicted in the scenario 500 of FIGS. 5A and 5B, the controller 505 may generate and provide a transmission 502 to the variable-focus imaging assembly 515 instructing the variable-focus imaging assembly 515 to capture 503 at least two images (e.g., full resolution images, low resolution ranging frames, etc.). The variable-focus imaging assembly 515 may capture 503 two images, and transmit 504 the image data comprising the two images to the controller 505. The controller 505 may compare parameters of each image to determine 501 whether the variable-focus imaging assembly 515 is within a threshold state of motion. In one example, the level of brightness of corresponding portions of each image (e.g., part of each image, the entire image, etc.) may be compared, and if there is a change in brightness in corresponding portions of the images, this may indicate the variable-focus imaging assembly 515 is in motion. Although in the implementation described the controller 505 compares the image parameters to make the determination 501, in other implementations an imaging processor and/or other suitable component communicatively coupled to the imaging device and/or controller may carry out the image parameter comparison and/or make the determination 501, e.g., and provide the indication of the determination 501 to the controller 505.

In at least some implementations, any motion of the variable-focus imaging assembly 515 may be considered as being outside a threshold state of motion. In other implementations, the state of motion of the variable-focus imaging assembly 515 may be compared to a threshold state of motion (e.g., a threshold stored in the memory 260, a LUT, etc.) to determine 501 whether the variable-focus imaging assembly 515 is outside the threshold state of motion. For example, the threshold state of motion may be a velocity of 1 (one) meter per second, and the state of motion of the variable-focus imaging assembly may be a velocity of 0.5 (one-half) meter per second (e.g., as indicated by a motion sensor), indicating the threshold state of velocity is not exceeded. The examples provided are for ease of illustration only, and any suitable method, component, and/or device may be used to determine 501 whether the variable-focus imaging assembly 515 is within a threshold state of motion.

If the determination 501 indicates the variable-focus imaging assembly 515 is outside the threshold state of motion, the controller 505 may cause the variable-focus imaging assembly 515 to abstain from at least one of: (i) performing the at least one focus operation (e.g., ranging, distance-based, focus bracketing, and/or ramping operations); (ii) capturing the at least one image frame; and/or (iii) transmitting the at least one image frame to the host, as previously described. In at least some implementations, the controller 505 may repeat (e.g., in a loop 507) the steps 502, 503, 504, until the determination 501 indicates the variable-focus imaging assembly 515 is within the threshold state of motion.

If the determination 501 indicates the variable-focus imaging assembly 515 is within the threshold state of motion, the controller 505 may cause the variable-focus imaging assembly 515 to: (i) perform at least one focus operation; (ii) capture at least one image frame; and (iii) transmit the at least one image frame to a host.

In at least one implementation, the focus operation is the ranging operation 509 previously described. The controller 505 may initialize the ranging operation 509 by transmitting 506 a signal to the variable-focus imaging assembly 515 to initiate the ranging operation 509. In response to transmission 502, the variable-focus imaging assembly 515 captures one or more images (e.g., ranging frames) during the ranging operation 509, as previously described. The variable-focus imaging assembly 515 may transmits 508 the image data from the ranging operation 509 to the controller 505.

In general, upon receiving the image data from a ranging operation, such as the ranging operations 509, the controller 505 may attempt to determine 511 the distance between the variable-focus imaging assembly 515 and a target object in the FOV, which may also include determining (e.g., via LUT) one or more range values, focus parameters and/or illumination parameters associated with the distance. With respect to ranging operation 509, if the controller 505 cannot determine 511 the distance based upon the transmission 508 of the images data (e.g., ranging frames) from the variable-focus imaging assembly 515, the controller 505 may transmit 550 a signal to initiate a ramping operation 527, as further described herein.

If the controller 505 successfully determines 511 the distance based upon the transmission 508, the controller 505 may transmit 510 a signal to the variable-focus imaging assembly 515 initiating a distance-based operation 513. The transmission 510 may indicate to the variable-focus imaging assembly 515 the distance, the focus parameters, the illumination parameters, etc., associated with the distance (e.g., from LUT). In response to the transmission 510, the variable-focus imaging assembly 515 may set a focus and illumination according to the focus parameters and illumination parameters respectively, e.g., in preparation for capturing images during the distance-based operation 513. During the distance-based operation 513, the variable-focus imaging assembly 515 captures one or more images comprising image data of the FOV of the variable-focus imaging assembly 515, using the focus parameters and illumination parameters. The variable-focus imaging assembly 515 transmits 512 the image data from the distance-based operation 513 to the controller 505. In general, although FIGS. 5A and 5B depict the variable-focus imaging assembly 515 capturing and transmitting the image data of the captured images in the same transmission 512, the variable-focus imaging assembly 515 may capture each image separately and transmit the associated image data separately, capture and/or transmit less than all the images and image data separately, any combination thereof, or operate in any other suitable manner.

The controller 505 may attempt to decode 517 an indicia, such as a barcode, in the image data of transmission 512. Upon a successful decode 517, the controller 505 may transmit 556 a signal, which results in controller 505 transmitting a termination signal via transmission 552 to the variable-focus imaging assembly 515, ending the scenario 500. In some implementations, the termination signal may result in the imaging assembly 515 initializing to focus/illumination parameters which may be indicated in the transmission 552, terminating image capture operations, and/or any other suitable response.

If the controller 505 does not successfully decode 517 the indicia from the image data, the controller 505 may transmit 514 a signal to the variable-focus imaging assembly 515 instructing the variable-focus imaging assembly 515 to initiate a second ranging operation 509A. The second ranging operation 509A may operate similarly to the first ranging operation 509, and detect the distance between the variable-focus imaging assembly 515 and the target object, as the distance may have changed between the first ranging operation 509 and the second ranging operation 509A. In response to transmission 514, the variable-focus imaging assembly 515 may initiate the second ranging operation 509A. As with the first ranging operation 509, the variable-focus imaging assembly 515 may capture one or more images during the ranging operation 509A. The variable-focus imaging assembly 515 transmits 520 the image data from the ranging operation 509A to the controller 505.

In at least some implementations, if the controller 505 cannot determine 511A a distance based upon the transmission 520 from the ranging operation 509A, the controller 505 may transmit 550A a signal to the initiate the ramping operation 527.

If the second ranging operation 509A determination 511A indicates the distance between the variable-focus imaging assembly 515 and the target object has changed since the first ranging operation 509, the scenario 500 may start over again, according to the controller 505 transmission 518, e.g., restarting the sequence 500 with the controller 505 providing the transmission 502.

If the second ranging operation 509A determination 511A indicates the distance between the variable-focus imaging assembly 515 and the target object has not changed since the first ranging operation 509, the controller may further determine 511A the focus parameters and illumination parameters (e.g., via LUT) associated with the distance of the ranging operation 509A. The controller 505 may transmit 522 a signal to the variable-focus imaging assembly 515 indicating a focus bracketing operation 519, which may also include the focus parameters and illumination parameters associated with the focus bracketing operation 519. The variable-focus imaging assembly 515 may then execute the focus bracketing operation 519, capturing a plurality of images throughout a focal zone associated with the distance from ranging operation 509A, and using the associated focus parameters and illumination parameters, as previously described. The variable-focus imaging assembly 515 may transmit 526 image data from the plurality of images captured during the focus bracketing operation 519 to the controller 505 to decode 517A an indicia contained in one or more images of the image data. Upon a successful decode 517A, the controller 505 may transmit 556A a signal, which results in a transmission 552 of a termination signal to the variable-focus imaging assembly 515, ending the scenario 500 as previously described. If the controller 505 does not successfully decode 517A indicia from the focus bracketing image data, the controller 505 may transmit 528 a signal to the variable-focus imaging assembly 515 to conduct a third ranging operation 509B. The third ranging operation 509B may be similar to the first 509 and second 509A ranging operations.

In response to transmission 528, the variable-focus imaging assembly 515 initiates the third ranging operation 509B. As with the other ranging operations 509, 509A, the variable-focus imaging assembly 515 captures one or more images during the ranging operation 509B. The variable-focus imaging assembly 515 transmits 534 the image data from the ranging operation 509B to the controller 505. If the controller 505 cannot determine 511B a distance based upon the transmission 534 from ranging operation 509B, the controller 505 transmits 536 a signal for the variable-focus imaging assembly 515 to initiate the ramping operation 527. The transmission 536 may instruct the variable-focus imaging assembly 515 to use focus parameters and illumination parameters associated with the last known range value (e.g., stored in memory and retrieved by controller 505 during determination 511B) during the ramping operation 509B, as previously described.

If the controller 505 determines 511B after the third ranging operation 509B the distance between the indicia reader and the target object has changed since the second ranging operation 509A, the scenario 500 may restart from the beginning according to the controller 505 transmission 518A. If the controller 505 successfully determines 511B the distance from transmission 534, and the distance remains the same between the second ranging operation 509A and third ranging operation 509B, the controller 505 may determine 511B the focus parameters and illumination parameters (e.g., via LUT) based upon the transmission 534. Next, the controller 505 may transmit 536 a signal instructing the variable-focus imaging assembly 515 to carry out the ramping operation 527, using the focus parameters and illumination parameters.

The ramping operation 527 may include capturing a plurality of images at various focal distances/across sequential focal zones, as previously described. In at least some embodiments, the focal distances may incrementally increase or decrease throughout various focal zones, resulting in the variable-focus imaging assembly 515 capturing images using multiple focal parameters (e.g., focus distance values), unless terminated, in an attempt to obtain a clear and/or adequately in-focus image of the indicia in the FOV, for subsequent decoding.

The ramping operation 527 may be ramped and incremented throughout steps of various focal distances. During each step of the ramping operation 527 having an associated focal distance, the imaging assembly may capture one or more images containing image data, which it transmits to the controller 505 for indicia decoding. If an indicia is successfully decoded 517B, the sequence 500 ends with the controller 505 initiating a transmission 556B, further resulting in terminal signal transmission 552 to the variable-focus imaging assembly 515, as previously described.

If there is no successful decode 517B, the ramping operation may enter a ramp incrementing loop 555. While in the loop 555, the controller 505 may transmit a signal 542 to the variable-focus imaging assembly 515 to ramp to the next step (which include ramping up or ramping down) in the ramping operation 527. The variable-focus imaging assembly 515 then captures one or more images associated with the incremented step, transmits 540 the image data from the images of the incremented step for subsequent decoding 517B by the controller 505. Incrementing the ramping operation to the next step may be repeated ad infinitum in the ramp incrementing loop 555, until a successful decode 517B from one or more images at one or more steps, until the controller 505 transmits 552 the termination signal, e.g., as a result of the user releasing the trigger of the imaging device, or any other suitable reason.

Although the sequence 500 describes conducting specific focus operation in a specific order upon determining 501 the variable-focus imaging assembly 515 does not exceed the threshold state of motion, this is for illustration only, as other focus operations may be initiated based upon the determination 501. In one example, determining 501 the variable-focus imaging assembly 515 does not exceed the threshold state of motion may be based upon ranging frames from a ranging operation. In such an example, the focus operation initiated by the controller 505 after the determination 501 may be the distance-based operation 513 (without the intervening ranging operation 509), the focus bracketing operation 519, the ramping operation 527, a focus ramping operation, and/or any other suitable focus operation.

Although the exemplary sequence 500 depicts the range value as being determined by the controller 505, this is for illustration purposes only. In some implementations, the variable-focus imaging assembly 515, another controller, a processor, or other suitable component/device associated with the imaging device may determine the range value.

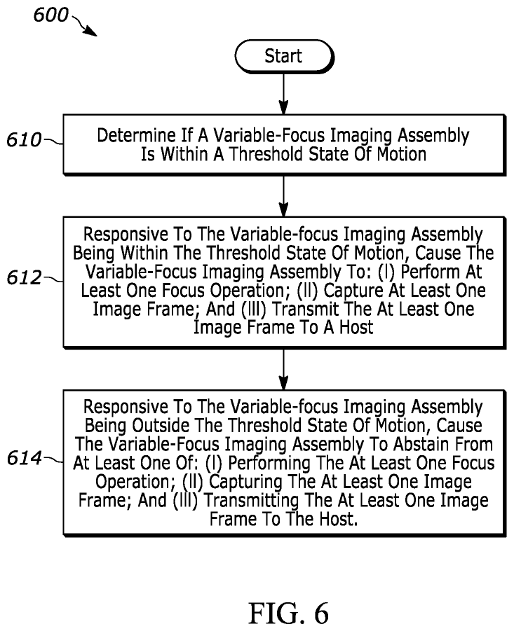

Referring next to FIG. 6, the method 600 illustrates a flow diagram of an example method of operating a variable-focus imaging assembly, such as indicia reader 100, imaging devices 200, 490. The method 600 may include at block 610, determining if the variable-focus imaging assembly is within a threshold state of motion. In some implementations, determining if the variable-focus imaging assembly is within the threshold state of motion (block 610) may include capturing, via the variable-focus imaging assembly, a first image frame and a second image frame, and determining if the variable-focus imaging assembly is within the threshold state of motion based upon comparing at least one first image frame parameter of the first image frame, and at least one second image frame parameter of the second image frame. In such an implementation, the first image frame and the second image frame may each have a lower resolution than the at least one image frame. In such an implementation, the at least one first image frame parameter may include a brightness parameter, and the at least one second image frame parameter may include the brightness parameter.

The method 600 may include at block 612, responsive to the variable-focus imaging assembly being within the threshold state of motion, causing the variable-focus imaging assembly to: (i) perform at least one focus operation; (ii) capture at least one image frame; and (iii) transmit the at least one image frame to a host. In at least some implementations, the host may be and/or include a decoding processor configured to decode an indicia in the at least one image frame. In such an implementation, the variable-focus imaging assembly and the decoding processor may be housed in a common sealed housing.

The method 600 may include at block 614, responsive to the variable-focus imaging assembly being outside the threshold state of motion, causing the variable-focus imaging assembly to abstain from at least one of: (i) performing the at least one focus operation; (ii) capturing the at least one image frame; or (iii) transmitting the at least one image frame to the host.

In some implementations of the method 600, the at least one focus operation may include a ranging operation causing the variable-focus imaging assembly to determine a distance between the variable-focus imaging assembly and a target, and set a focus of the variable-focus imaging assembly based upon the distance between the variable-focus imaging assembly and the target.

In some implementations of the method 600, the at least one focus operation includes a ramping operation causing the variable-focus imaging assembly to set a focus of the variable-focus imaging assembly to at least two focus values, and capture at least one focused image frame at each of the at least two focus values.

In some implementations, the method 600 may include, responsive to a trigger event, performing (a)-(c) until at exceeding a timeout period, and/or receiving a termination signal. In such an implementation, the termination signal may be received from the host, and based upon a successful decode of an indicia in the at least one image frame by the host.

It will be understood that the foregoing represents one potential implementation, and that other implementations may be envisioned. For example, in some implementations, a bi-optic barcode scanner may be used as the imaging device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method of operating a variable-focus imaging assembly, the method comprising:
(a) determining if the variable-focus imaging assembly is within a threshold state of motion;
(b) responsive to the variable-focus imaging assembly being within the threshold state of motion, causing the variable-focus imaging assembly to:
(i) perform at least one focus operation;
(ii) capture at least one image frame; and
(iii) transmit the at least one image frame to a host; and
(c) responsive to the variable-focus imaging assembly being outside the threshold state of motion, causing the variable-focus imaging assembly to abstain from at least one of:
(i) performing the at least one focus operation;
(ii) capturing the at least one image frame; and
(iii) transmitting the at least one image frame to the host,
wherein the being within the threshold state of motion is associated with the variable-focus imaging assembly being in a more stable state than being outside the threshold state of motion.

2. The method of claim 1, wherein the at least one focus operation includes a ranging operation causing the variable-focus imaging assembly to:
determine a distance between the variable-focus imaging assembly and a target; and
set a focus of the variable-focus imaging assembly based upon the distance between the variable-focus imaging assembly and the target.

3. The method of claim 1, wherein the at least one focus operation includes a ramping operation causing the variable-focus imaging assembly to:
set a focus of the variable-focus imaging assembly to at least two focus values; and
capture at least one focused image frame at each of the at least two focus values.

4. The method of claim 1, further comprising:
responsive to a trigger event, performing (a)-(c) until at least one of:
exceeding a timeout period; or
receiving a termination signal.

5. The method of claim 4, wherein the termination signal is:
received from the host; and
based upon a successful decode of an indicia in the at least one image frame by the host.

6. The method of claim 1, wherein the determining if the variable-focus imaging assembly is within the threshold state of motion includes:
capturing, via the variable-focus imaging assembly, a first image frame and a second image frame; and
determining if the variable-focus imaging assembly is within the threshold state of motion based upon comparing at least one first image frame parameter of the first image frame and at least one second image frame parameter of the second image frame.

7. The method of claim 6, wherein the first image frame and the second image frame each have a lower resolution than the at least one image frame.

8. The method of claim 6, wherein:
the at least one first image frame parameter includes a brightness parameter; and
the at least one second image frame parameter includes the brightness parameter.

9. The method of claim 1, wherein the host is a decoding processor configured to decode an indicia in the at least one image frame.

10. The method of claim 9, wherein the variable-focus imaging assembly and the decoding processor are housed in a common sealed housing.

11. A system for operating a variable-focus imaging assembly, the system comprising:
the variable-focus imaging assembly;
a controller of the variable-focus imaging assembly;
one or more processors; and
a memory storing instructions that, when executed by the one or more processors, cause the one or more processors to:
(a) determine if the variable-focus imaging assembly is within a threshold state of motion;
(b) responsive to the variable-focus imaging assembly being within the threshold state of motion, cause the variable-focus imaging assembly to:
(i) perform at least one focus operation;
(ii) capture at least one image frame; and
(iii) transmit the at least one image frame to a host; and
(c) responsive to the variable-focus imaging assembly being outside the threshold state of motion, cause the variable-focus imaging assembly to abstain from at least one of:
(i) performing the at least one focus operation;
(ii) capturing the at least one image frame; and
(iii) transmitting the at least one image frame to the host,
wherein the being within the threshold state of motion is associated with the variable-focus imaging assembly being in a more stable state than being outside the threshold state of motion.

12. The system of claim 11, wherein the at least one focus operation includes a ranging operation, the ranging operation further comprising the one or more processors being configured to cause the variable-focus imaging assembly to:
determine a distance between the variable-focus imaging assembly and a target; and
set a focus of the variable-focus imaging assembly based upon the distance between the variable-focus imaging assembly and the target.

13. The system of claim 11, wherein the at least one focus operation includes a ramping operation, the ramping operation further comprising the one or more processors being configured to cause the variable-focus imaging assembly to:
set a focus of the variable-focus imaging assembly to at least two focus values; and
capture at least one focused image frame at each of the at least two focus values.

14. The system of claim 11, further comprising the one or more processors being configured to:
responsive to a trigger event, perform (a)-(c) until at least one of:
exceeding a timeout period; or
receiving, by the controller, a termination signal.

15. The system of claim 14, wherein the termination signal is:
received from the host; and
based upon a successful decode of an indicia in the at least one image frame by the host.

16. The system of claim 11, wherein to determine if the variable-focus imaging assembly is within the threshold state of motion, the one or more processors are further configured to:
capture, via the variable-focus imaging assembly, a first image frame and a second image frame; and
determine if the variable-focus imaging assembly is within the threshold state of motion based upon comparing at least one first image frame parameter of the first image frame and at least one second image frame parameter of the second image frame.

17. The system of claim 16, wherein the first image frame and the second image frame each have a lower resolution than the at least one image frame.

18. The system of claim 16, wherein:
the at least one first image frame parameter includes a brightness parameter; and
the at least one second image frame parameter includes the brightness parameter.

19. The system of claim 11, wherein the host is a decoding processor configured to decode an indicia in the at least one image frame.

20. A tangible machine-readable medium comprising instructions that, when executed, cause a machine to at least:
(a) determine if a variable-focus imaging assembly is within a threshold state of motion;
(b) responsive to the variable-focus imaging assembly being within the threshold state of motion, cause the variable-focus imaging assembly to:
(i) perform at least one focus operation;
(ii) capture at least one image frame; and
(iii) transmit the at least one image frame to a host; and
(c) responsive to the variable-focus imaging assembly being outside the threshold state of motion, cause the variable-focus imaging assembly to abstain from at least one of:
(i) performing the at least one focus operation;
(ii) capturing the at least one image frame; and
(iii) transmitting the at least one image frame to the host,
wherein the being within the threshold state of motion is associated with the variable-focus imaging assembly being in a more stable state than being outside the threshold state of motion.
